(19) United States
(12) Patent Application Publication
(10) Pub. No.: US 2006/0191648 A1
(43) Pub. Date: Aug. 31, 2006

(54) Vertical blind with outward facing radiant barrier

(76) Inventor: Dennis P. Vlach, Lake Elsinore, CA (US)

Correspondence Address: AVERILL & VARN, 8244 PAINTER AVE., WHITTIER, CA, 90602, US

(21) Appl. No.: 11/069,688

(22) Filed: Feb. 28, 2005

(51) Int. Cl. E06B 3/12

(52) U.S. Cl. 160/236

(57) ABSTRACT

A vertical panel includes a back sheet and a clear cover which attaches to the back sheet. Space is provided between the back sheet and the clear cover to allow a decorative strip to reside between the back sheet and the clear cover. The back sheet may be made from aluminum or aluminum covered material and a rear, or outward facing, surface of the back sheet is a radiant barrier surface. The back sheet and the clear cover preferably snap together to allow easy insertion of the decorative strip, and more preferable the clear cover includes attaching edges shaped to snap onto edges of the back sheet. The back sheet thus must be sufficiently rigid to allow the cover to snap into place. The decorative strip may be a wallpaper strip matched to wallpaper used in a room, or providing contrast to wallpapered or painted walls in the room.

### BACKGROUND OF THE INVENTION

The present invention relates to window coverings and in particular to a vertical blind having a decorative inward facing side and a radiant barrier outward facing side.

Modern residences and office are desired to both provide attractive surroundings and to be energy efficient. Because of the number and locations of windows, window coverings have a significant effect on the appearance of a room. Further, because windows are intended to allow sunlight to pass through, windows generally provide less insulation than walls, and therefor uncovered window may have a significant effect on heating and cooling costs.

Windows are commonly covered by blinds, and in many cases by vertical blinds. Known blinds commonly included vertical back sheets with channels along each edge allowing a decorative covering to be inserted therein, thereby covering an inward facing side of the back sheets. An outward facing side of the vertical panels is generally unfinished. Because the channels are part of the back sheets, the back sheets are generally formed of inexpensive plastic material to control costs. Such plastic back sheets tend to absorb radiant heat, and thus draw heat into a room, and add to air conditioning costs, or radiate heat on a cold day, and add to heating costs.

### BRIEF SUMMARY OF THE INVENTION

The present invention addresses the above and other needs by providing a vertical panel which includes a back sheet and a clear cover which attaches to the back sheet. Space is provided between the back sheet and the clear cover to allow a decorative strip to reside between the back sheet and the clear cover. The back sheet may be made from aluminum or aluminum covered material and a rear, or outward facing, surface of the back sheet is a radiant barrier surface. The back sheet and the clear cover preferably snap together to allow easy insertion of the decorative strip, and more preferable the clear cover includes attaching edges shaped to snap onto edges of the back sheet. The back sheet thus must be sufficiently rigid to allow the cover to snap into place. The decorative strip may be a wallpaper strip matched to wallpaper used in a room, or providing contrast to wallpapered or painted walls in the room.

In accordance with one aspect of the invention, there is provided a vertical blind panel comprising a metal back sheet having a radiant barrier back side and an extruded cover sheet having attaching edges adapted to grasp edges of the back sheet to attach the cover sheet to the back sheet. The back sheet is preferably an aluminum back sheet or an aluminum surfaced back sheet. The cover sheet is preferably a clear cover sheet allowing viewing of a decorative insert between the cover sheet and the back sheet, and is preferably made from a UV resistant material.

In accordance with another aspect of the invention, there is provided a method for constructing a vertical panel for a vertical blind. The method includes measuring a length of metal sheet, cutting a portion of the metal sheet to make a metal back sheet, and snapping a cover sheet onto the metal back sheet on a side of the metal back sheet opposite a radiant barrier side of the metal back sheet. The metal back sheet is preferably cut from a metal coil, and more preferably from an aluminum coil having the same width as the finished back sheet.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is room having a window covered by vertical window blinds and a doorway covered by vertical doorway blinds.

FIG. 2 is a short vertical panel of the vertical blinds suitable for covering a window.

FIG. 2B a long vertical panel of the vertical doorway blinds.

FIG. 3 is a cross-sectional view to taken along line 3-3 of FIG. 2B of a vertical panel according to the present invention.

FIG. 4 is a detailed cross-sectional view taken along line 3-3 of FIG. 2B of the vertical panel according to the present invention.

FIG. 5 is a rigid back sheet element of the vertical panel according to the present invention.

FIG. 6 is a transparent clear cover which attaches to the rigid back sheet according to the present invention.

FIG. 7 is a detailed cross-sectional view takes a long line 3-3 of FIG. 2B of a second embodiment of the cover sheet.

FIG. 8 is a coil of aluminum and a back sheet section cut from the coil.

FIG. 9 is a method according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

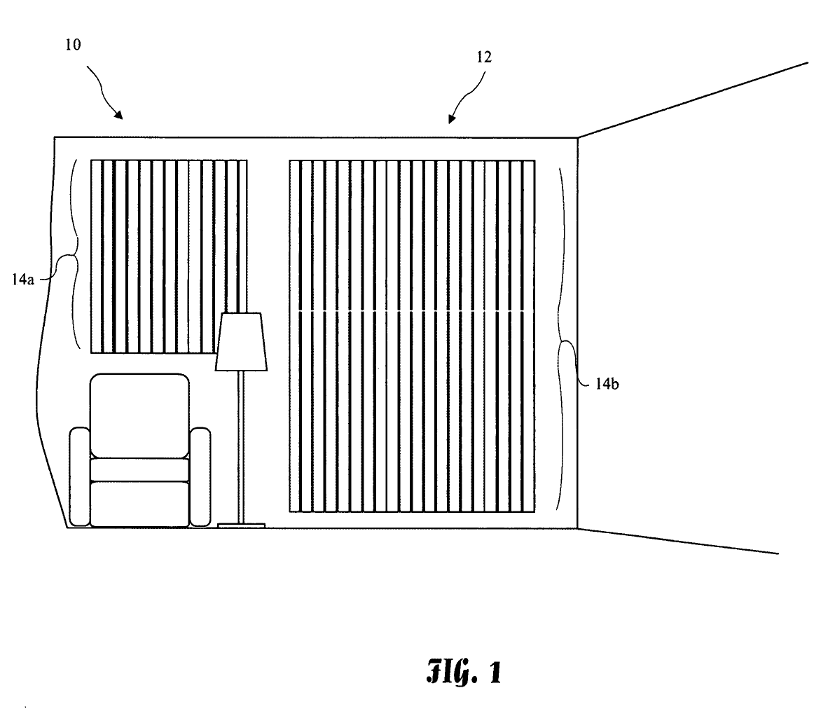

A room having a window 10 covered by vertical blinds 14a and a sliding glass doorway 12 covered by vertical blinds 14b is shown in FIG. 1. Vertical blinds 14a and 14b are commonly used to provide a decorative appearance to rooms and to provide some degree of thermal insulation to windows and doors. Although known vertical blinds 14a and 14b provide a degree of insulation, the known blinds generally have a non-radiate barrier backside which may absorb heat from outside the house which in turn results in the undesirable heating of a room, or which may radiate heat from the room which in turns results in undesirable cooling of the room.

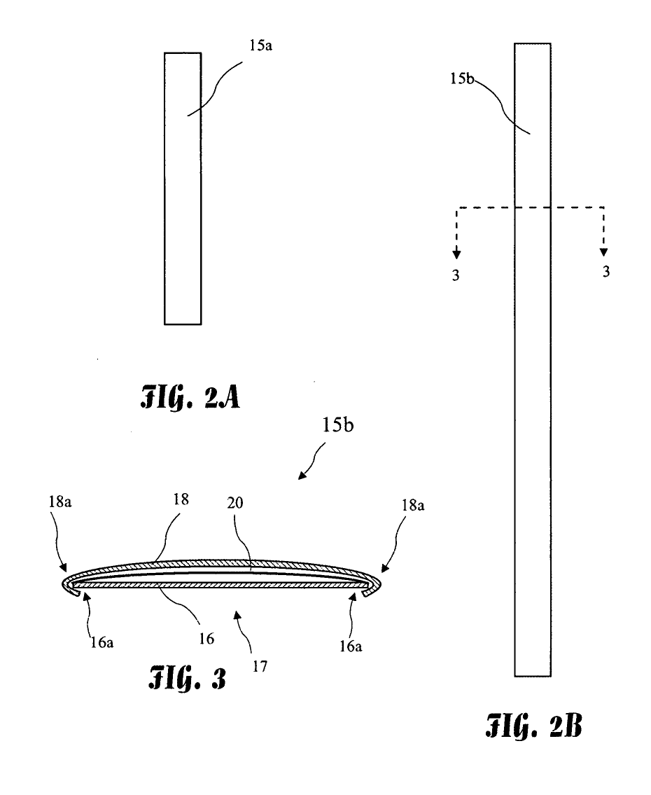

A short vertical panel 15a of the vertical blinds 14a is shown in FIG. 2A, and the long vertical panel 15b of the vertical blinds 14b is shown in FIG. 2B. The vertical blinds 14a and 14b are constructed from a multiplicity of vertical panels 15a and 15b respectively. Generally, the vertical panels 15a and 15b may be gathered to one-sided of the window 10 or doorway 12, or may be angled, to allow sunlight to enter a room or to allow opening of a door 12 or window 10.

A cross-sectional view of the vertical panel 15b taken along line 3-3 of FIG. 2B is shown in FIG. 3. The vertical panel 15b comprises a back sheet 16, a cover sheet 18, and a decorative insert 20 residing between the back sheet 16 and the cover sheet 18. The back sheet 16 is preferably a simple flat-panel without a channel or any other feature specifically provided for attaching the cover sheet 18 to the back sheet 16. The cover sheet 18 cooperates with back sheet edges 16a to attach the cover sheet 18 to the back sheet 16. The back sheet 16 is preferably sufficiently rigid to allow the cover sheet 18 to firmly attach to the back sheet 16, and is preferably a rigid back sheet 16. The simple flat structure of the back panel 16 allows for low cost manufacturing, for example, much cheaper than the cost of extruding a metal panel.

The vertical panel 15 be shown in greater detail in FIG. 4. The cover sheet 18 includes attaching edges 18a having a “C” shape which cooperates with back sheet edges 16a to attach the cover sheet 18 to the back sheet 16.

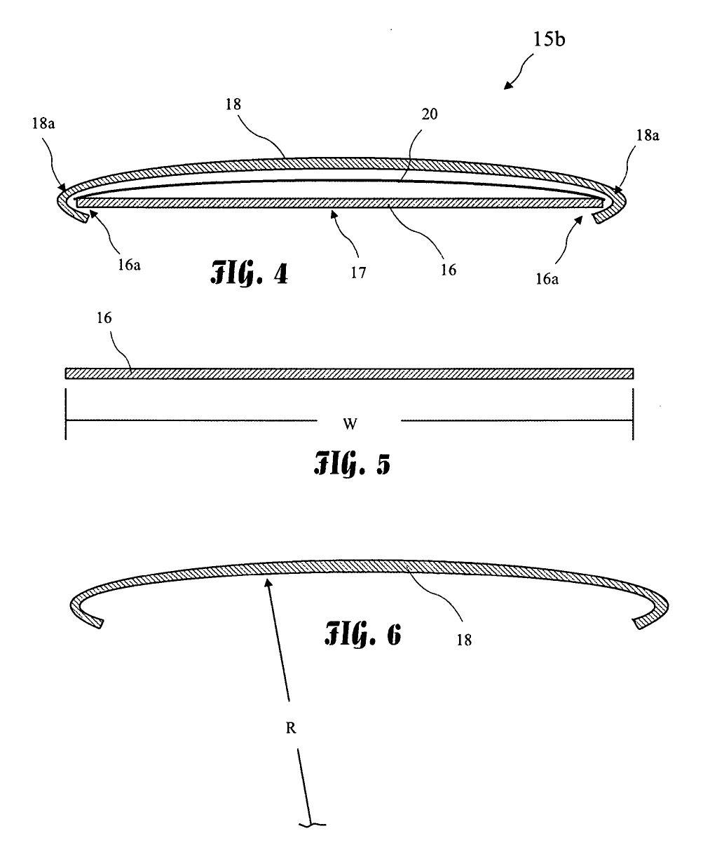

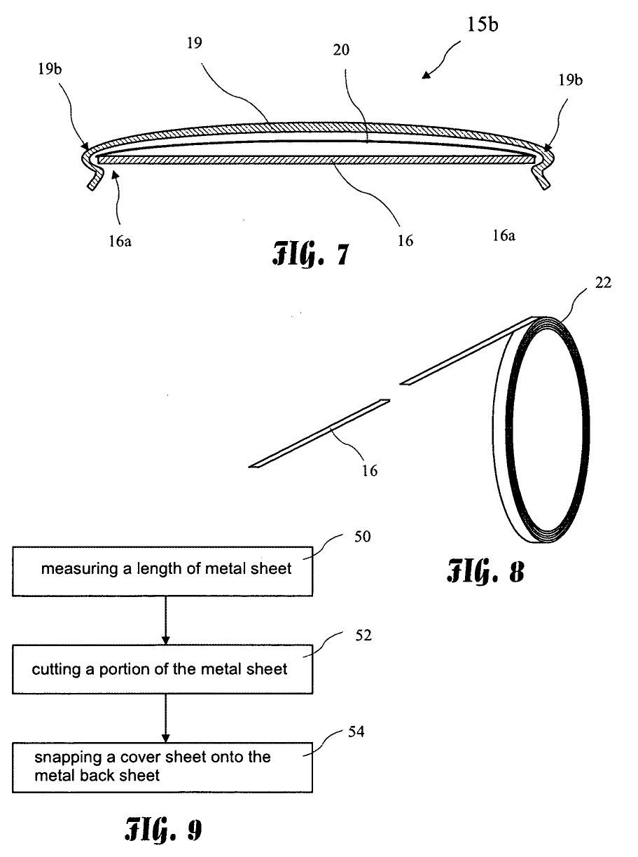

The back sheet 16 is shown in detail in FIG. 5. The back sheet 16 has a width W which is preferably between 2 inches and 5 inches, and is more preferably approximately 3.4 inches. Preferably, the back sheet 16 is an aluminum back sheet or an aluminum covered back sheet (e.g., an aluminum foil, aluminum coated paper, or aluminum layer over plastic, particle board, cardboard, or the like), more preferably, the back sheet 16 an aluminum back sheet, and most preferably, the back sheet 16 is an aluminum back sheet cut from an aluminum coil 22 (see FIG. 8). A preferred aluminum is commonly available 5052-H32 aluminum. The aluminum coil 22 is preferably provided in the correct final width of the back sheet 16, therefore cutting the back sheet 16 merely requires a crosscut of the aluminum sheet drawn from the aluminum coil 22. At least one side of the back sheet 16 comprises a radiant barrier surface, and is preferable an aluminum surface, and is most preferably an unpainted aluminum surface providing the radiant barrier. The radiant barrier of the back sheet 16 reflects heat otherwise absorbed by the vertical panels 15a and 15b. Reflecting the heat may substantially reduce air-conditioning costs in homes, offices, and the like in areas such as the southwest United States. The effectiveness of a radiant barrier may be measured in term of the emissivity of the surface. The emissivity of the back side 17 of the back sheet 16 is preferably less than approximately 0.10, more preferably less than approximately 0.06, and most preferably less than approximately 0.04.

A detailed cross-sectional view of the cover sheet 18 is shown in FIG. 6. The cover sheet 18 is preferably describes an arc with a radius of between 3 feet and 7 feet and more preferably a radius of approximately 5.55 feet. The cover sheet 18 may be a decorative cover sheet or may be a clear or transparent cover sheet allowing viewing of the decorative insert 20. In the case of a clear or transparent cover sheet 18, the cover sheet 18 is preferably made from a non-yellowing material, and is more preferably made from an Ultra Violet (UV) resistant material and is most preferably made from polycarbonate.

An embodiment of the vertical panel 15b having a second cover sheet 19 is shown in FIG. 7. The second cover sheet 19 includes “S” shaped cover sheet attaching edges 19b.

A metal coil 22 providing material for manufacturing the back sheet 16 is shown in FIG. 8. The metal coil 22 preferably provides metal of the finished width of the back sheet 16. The back sheet 16 is manufacture by drawing metal stripping from the metal coil 22 and cross cutting the metal stripping at the correct length of the back sheet 16. The metal coil 22 is preferably an aluminum coil, and the aluminum sheet on the aluminum coil 22 preferably has a least one surface providing a radiant barrier for the back sheet 16.

A method according to the present invention is described in FIG. 9. The method includes the steps of measuring a length of sheet metal having the width of a finished back sheet at step 50, cutting a portion of the metal sheet to make the back sheet at step 52, and snapping a cover sheet on to the back sheet at step 54. Measuring the length of sheet preferably comprises measuring a length of metal sheet rolled off of a metal coil, and more preferably comprises measuring a length of metal sheet rolled off of an aluminum coil.

While the invention herein disclosed has been described by means of specific embodiments and applications thereof, numerous modifications and variations could be made thereto by those skilled in the art without departing from the scope of the invention set forth in the claims.

I claim:

1. A vertical blind panel comprising:
a rigid back sheet having a radiant barrier back side; and
a cover sheet detachably attachable to a front side of the rigid back sheet.

2. The panel of claim 1, wherein the rigid back sheet is a flat back sheet.

3. The panel of claim 1, wherein the rigid back sheet has at least one aluminum surface.

4. The panel of claim 1, wherein the rigid back sheet is made from aluminum.

5. The panel of claim 4, wherein the rigid back sheet is made from aluminum from an aluminum coil.

6. The panel of claim 5, wherein the aluminum taken from the aluminum coil has the same width as the finished back sheet.

7. The panel of claim 1, wherein the rigid back sheet has a flat inner surface and a flat outer surface.

8. The panel of claim 1, wherein the cover sheet is a transparent cover sheet.

9. The panel of claim 8, wherein the cover sheet is made from an Ultra Violet (UV) resistant material.

10. The panel of claim 8, wherein the cover sheet is made from polycarbonate.

11. The panel of claim 8, wherein a decorative strip resides between the cover sheet and the back sheet.

12. The panel of claim 1, wherein the cover sheet is a decorative cover sheet.

13. The panel of claim 1, wherein the cover sheet includes attaching edges curved to grasp back sheet edges of the back sheet.

14. The panel of claim 13, wherein the attaching edges of the cover sheet are “C” shaped edges.

15. The panel of claim 13, wherein the attaching edges of the cover sheet are “S” shaped edges.

16. A vertical blind panel comprising:
a metal back sheet having a radiant barrier back side; and
an extruded cover sheet having attaching edges adapted to grasp edges of the back sheet to attach the cover sheet to the back sheet.

17. The panel of claim 16, wherein the back sheet is made from aluminum and the radiant barrier back side is an unpainted aluminum surface.

18. A method for manufacturing a vertical blond panel, comprising:
measuring a length of metal sheet;
cutting a portion of the metal sheet to make a metal back sheet; and
snapping a cover sheet onto the metal back sheet on a side of the metal back sheet opposite a radiant barrier side of the metal back sheet.

19. The method of claim 18, wherein measuring a length of metal sheet comprises measuring a length of metal sheet rolled off of a metal coil.

20. The method of claim 18, wherein measuring a length of metal sheet comprises measuring a length of metal sheet rolled off of an aluminum coil.
